(19) United States
(12) Patent Application Publication
(10) Pub. No.: US 2026/0127848 A1
(43) Pub. Date: May 7, 2026

(54) EVALUATION OF AUTO-POSITIONING SOFTWARE PERFORMANCE WITH GENERATIVE ARTIFICIAL INTELLIGENCE

(71) Applicant: GE Precision Healthcare LLC, Waukesha, WI (US)

(72) Inventors: Tisha Anie Abraham, Bengaluru (IN); Dattesh Dayanand Shanbhag, Bengaluru (IN); Chitresh Bhushan, Schenectady, NY (US); Vanika Singhal, Bangalore (IN); Apoorva Anil Agarwal, Bengaluru (IN); Bhavatharani S, Bengaluru (IN)

(21) Appl. No.: 18/940,022

(22) Filed: Nov. 7, 2024

(51) Int. Cl. G06V 10/75; G06T 11/00; G06V 10/44; G06V 10/74

(52) U.S. Cl. CPC G06V 10/751; G06T 11/00; G06V 10/44; G06V 10/761

(57) ABSTRACT

One or more systems, devices, computer program products and/or computer-implemented methods of use provided herein relate to generative artificial intelligence (AI)-based large-scale automated evaluation of autonomous planning software (APS) performance. For example, a system can comprise a memory that can store computer executable components and a processor that can execute the computer executable components stored in the memory. The computer executable components can comprise an image generation component that can generate one or more diagnostic images. The computer executable components can further comprise an image evaluation component that can generate, based on defined image criteria, respective auto-positioning image matching scores for respective diagnostic images of the one or more diagnostic images by comparing the respective diagnostic images with respective sets of template images.

### BACKGROUND

The subject disclosure relates to artificial intelligence (AI) and, more specifically, to large-scale automated evaluation of Auto-positioning Software or Autonomous Planning Software (APS) performance with generative AI.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable evaluation of APS performance with generative AI are provided.

According to an embodiment, a system is provided. The system can comprise a memory that can store computer executable components. The system can further comprise a processor that can execute the computer executable components stored in the memory, where the computer executable components can comprise an image generation component that can generate one or more diagnostic images. The computer executable components can further comprise an image evaluation component that can generate, based on defined image criteria, respective auto-positioning image matching scores for respective diagnostic images of the one or more diagnostic images by comparing the respective diagnostic images with respective sets of template images.

According to another embodiment, a computer-implemented method is provided. The computer-implemented method can comprise generating, by a system operatively coupled to a processor, one or more diagnostic images. The computer-implemented method can further comprise generating, by the system, based on defined image criteria, respective auto-positioning image matching scores for respective diagnostic images of the one or more diagnostic images by comparing the respective diagnostic images with respective sets of template images.

According to yet another embodiment, a computer program product is provided. The computer program product can comprise a non-transitory computer readable memory having program instructions embodied therewith, the program instructions executable by a processor to cause the processor to generate one or more diagnostic images. The program instructions can be further executable by the processor to cause the processor to generate, based on defined image criteria, respective auto-positioning image matching scores for respective diagnostic images of the one or more diagnostic images by comparing the respective diagnostic images with respective sets of template images.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a block diagram of an example, non-limiting system that can employ generative AI to evaluate the performance of an APS in accordance with one or more embodiments described herein.

FIG. 2 illustrates another block diagram of an example, non-limiting system that can employ generative AI to evaluate the performance of an APS in accordance with one or more embodiments described herein.

FIG. 3 illustrates a flow diagram of an example, non-limiting method that can employ generative AI to evaluate the performance of an APS in accordance with one or more embodiments described herein.

FIG. 4 illustrates another flow diagram of an example, non-limiting method that can employ generative AI to evaluate the performance of an APS in accordance with one or more embodiments described herein.

FIG. 5 illustrates example, non-limiting images associated with the performance evaluation of an APS.

FIG. 6 illustrates a flow diagram of an example, non-limiting method to show the use of APS to generate multi-planar images of a human brain in accordance with one or more embodiments described herein.

FIG. 7 illustrates a flow diagram of an example, non-limiting method to show the use of APS to generate multi-planar images of a human knee in accordance with one or more embodiments described herein.

FIG. 8 illustrates a flow diagram of an example, non-limiting method that can be employed by an algorithm to perform template-based matching of diagnostic images in accordance with one or more embodiments described herein.

FIG. 9 illustrates a flow diagram of an example, non-limiting method that can be employed by an algorithm to determine error tolerance limits for diagnostic images in accordance with one or more embodiments described herein.

FIG. 10 illustrates a diagram of an example, non-limiting dashboard that can be employed in triaging in accordance with one or more embodiments described herein.

FIG. 11 illustrates a diagram of an example, non-limiting dashboard that shows images of a human knee employed in an intelligent multi-planar reformatting (iMPR) workflow in accordance with one or more embodiments described herein.

FIG. 12 illustrates a diagram of an example, non-limiting dashboard that shows images of a human brain employed in an iMPR workflow in accordance with one or more embodiments described herein.

FIG. 13 illustrates a flow diagram of an example, non-limiting method that can employ generative AI to evaluate performance of an APS in accordance with one or more embodiments described herein.

FIG. 14 illustrates a block diagram of an example, non-limiting operating environment in which one or more embodiments described herein can be facilitated.

FIG. 15 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Automated methods to generate accurate images of an anatomical landmark or part of an anatomy are increasingly employing APS with the aim of fostering precision imaging without depending on the skill of an imaging technologist and report generation. Examples of such methods include the AIRx™ suite of applications by General Electric Healthcare (GEHC) for magnetic resonance imaging (MRI) that allow an MRI scanner to automatically determine the three-dimensional (3D) scan plane for anatomies, irrespective of patients' positions during scanning, and intelligent reformatting of acquired volumes retrospectively (complementing AIRx™ in magnetic resonance (MR) or Head Auto Views (HAV) in computed tomography (CT)). Beyond the training-validation-test datasets, the accuracy and robustness of these methods are generally tested on new data (data previously unseen by models) that is obtained in-house (e.g., at a hospital, clinic, etc.) with volunteer scans and/or with retrospective reformatting of clinical data. Since no ground truth (GT) information is available on the new data, the performance of APS on the new data is assessed manually, and the effectiveness of the APS is determined by technologists/radiologists by employing desirable criteria. Such inspection is an extremely manual process that restricts the performance evaluation of the APS to a limited/small set of datapoints/volunteers. This can lead to a long and iterative APS development cycle. Further, marking ground truth data based on the new data is highly impractical and expensive, and doing so can make the manual inspection even more time-consuming. On-site evaluation of the APS post deployment is also limited because diagnostic images acquired at a location/site by employing APS cannot be provided (for example, to GEHC or another company) due to privacy and legal concerns.

Inventors of the present application recognized that the entire process to evaluate the performance of an APS is based on certain objective criteria/define image criteria that depend on the anatomical landmarks employed to acquire diagnostic images via the APS. Examples of such criteria include no tilt or symmetry in data, contiguous visualization of structures, adequate field of view (FOV) for landmark structures, etc. This suggests that the methods and techniques employed to evaluate the performance of the APS can be automated to assess adherence of the APS to such defined image criteria based on the acquired diagnostic images either (a) in a prospective manner or (b) by employing APS planes to reformat a 3D volume. Employing such a methodology in combination with large clinical databases and data sources both internally and externally (The Cancer Imaging Archive (TCIA), Alzheimer's Disease Neuroimaging Initiative (ADNI), various biobanks, etc.) can automate the task of performance evaluation of APS.

Accordingly, the various embodiments described herein include systems, computer-implemented methods, and computer program products that can enable a generative AI-based framework for automated performance evaluation of APS (also, APS performance evaluation framework, APS assessment framework, automated APS assessment framework, etc.). In various embodiments, the APS performance evaluation framework can comprise determining, from large databases, suitable datasets that match the defined image criteria employed by the APS, running the APS on such matching data, generating, by employing an intelligent multi-planar reformatting/reformat (iMPR) tool, desired reformatted data based on outputs generated by the APS, and employing foundation models to perform image criteria-based performance evaluation by employing template images as examples of desirable images. In various embodiments, template images can be employed to evaluate the performance of the APS because the defined image criteria employed for the performance evaluation can vary based on the anatomical landmark being image, and developing small models for each anatomical landmark is not practical. Further, employing one or more template images in combination with foundation model (FM) scoring can alleviate the need to mathematically define or quantify the desirable defined image criteria for each anatomical landmark or plane. In various embodiments, the foundation models can be incorporated in the APS performance evaluation framework by employing their capabilities to perform image matching, wherein diagnostic images generated by the APS can be matched against pre-selected diagnostic images representing templated examples of good data acquisition through attributes such as complete visualization of structure, entire FOV, etc. The scores thus generated can be triaged and displayed to a clinical subject matter expert (SME)/clinical SME for a quick review, and the clinical SME can ascertain the quality of the proposed framework. Any corrections to the evaluation of the framework, if needed, can be applied via the iMPR tool, and recorded to rebase the ground truth.

It should be appreciated that although the various embodiments of the present disclosure are largely described with reference to specific medical product lines, the various embodiments herein can also be applied across product lines employing APS. For example, the various embodiments herein can be applicable to APS for MRI, CT, ultrasound, or any other modality. Further, the various embodiments herein can be employed in any industry other than the healthcare industry. Embodiments of the present disclosure provide several customer/patient benefits. For example, the APS performance evaluation framework described in various embodiments can be employed without employing new labeling or ground truth. The APS performance evaluation framework can comprise the ability to harness large pools of clinical datasets available in-house (Sherlock) as well as open-databases (e.g. TCIA, ADNI, various biobanks, etc.) and the ability to perform a single-shot evaluation of the performance of an APS on a large variety of datasets during the development cycle of the APS. This can result in a shorter development cycle with quick assessment of failures within the APS and eliminate the need to await the realization of such failures until external clinical feedback is available after product release. The APS performance evaluation framework can also employ one or more foundation models (FMs) and one or more vision transformers (ViT)s to enable a quick template-based assessment of what constitutes good APS performance, which can eliminate the need to develop multiple individual models to ascertain the same for different anatomical landmarks. Additionally, the APS performance evaluation framework can be deployed at a location such as a medical facility to assess APS model performance in the field without accessing the imaging data from the location remotely and logging the information for further review, for example, through Kibana® databases.

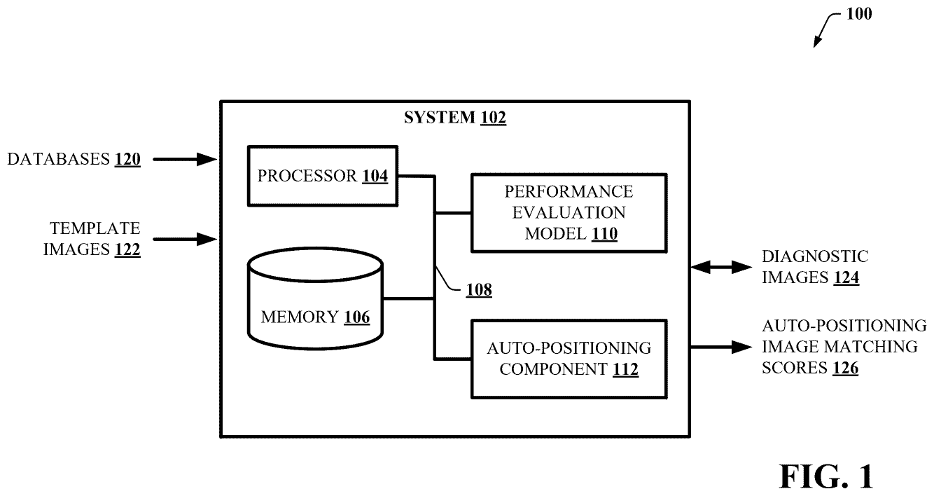

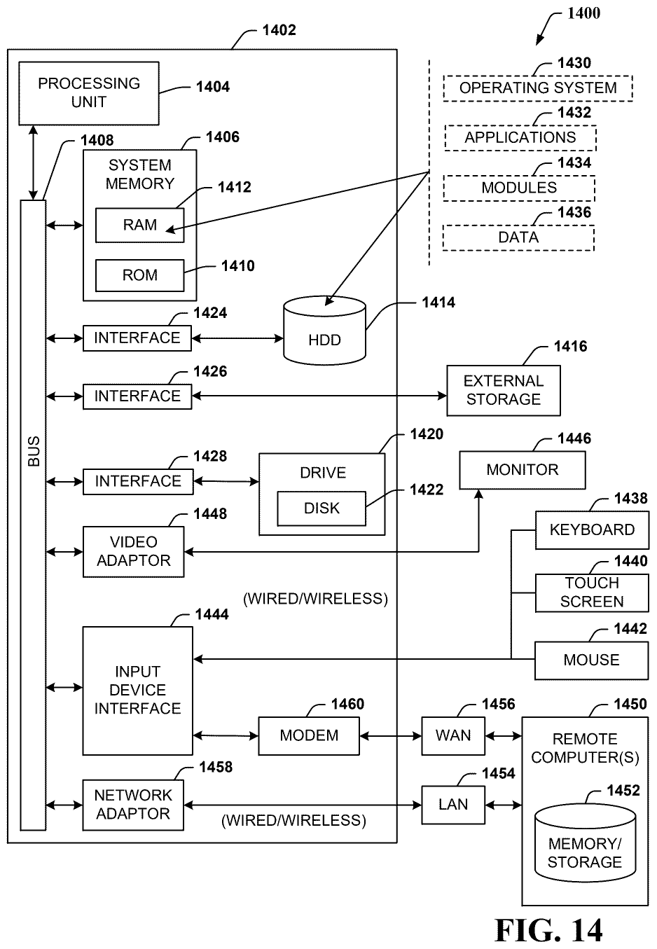

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can employ generative AI to evaluate the performance of an APS in accordance with one or more embodiments described herein.

Non-limiting system 100 and/or the components of non-limiting system 100 can be employed to use hardware and/or software to solve problems that are highly technical in nature (e.g., related to APS, generative AI, etc.), that are not abstract and that cannot be performed as a set of mental acts by a human. Further, some of the processes performed may be performed by specialized computers for carrying out defined tasks related to evaluation of APS performance with generative AI. Non-limiting system 100 and/or components of non-limiting system 100 can be employed to solve new problems that arise through advancements in technologies mentioned above and/or the like. Non-limiting system 100 can provide technical improvements to APS evaluation systems by reducing the development time for APS, increasing the accuracy of performance evaluation of an APS, and reducing the time spent in evaluating the performance of the APS. For example, in various embodiments, an APS performance evaluation system is provided that can be safer than existing APS performance evaluation methods because such non-limiting system 100 can introduce objectivity to APS performance assessment and eliminate user bias. The APS performance evaluation system can be applied to a wide range of clinical data during the cycle of APS development, improve regulatory compliance and simplify regulatory submissions, increase trust in a company's APS and reduce the development cycle for an APS by eliminating the need for iterative development.

The primary advantage of the APS performance evaluation system described in various embodiments can be that the system can perform evaluations on a large variety of clinical datasets covering numerous medical conditions of patients, thereby analyzing the robustness of an APS in a single shot/single evaluation. The results of the evaluation can be provided as feedback to APS developers, wherein the feedback can report on the shortcomings of the APS or indicate that the APS has achieved a milestone needed for deployment of the APS in the field (e.g., a location such as a medical facility). The APS performance evaluation framework described in various embodiments can accelerate the product development cycle for APS and allow for unbiased evaluation of APS.

Additionally, the results of the evaluation can be further analyzed by clinical SMEs via a dashboard to generate additional feedback on the performance of the APS that can strengthen the quality of the APS from a regulatory standpoint. Overall, the APS performance evaluation framework can tremendously accelerate the entire review process for an APS and quickly highlight any shortcomings in the APS, thereby reducing chances of failure when the APS is deployed in the field. In one or more embodiments, the APS performance evaluation framework can be deployed in the field to assess the performance of an APS on the field and report performance logs to the concerned entities (e.g., hardware, software, machine, AI, neural network and/or user), without needing to send data (e.g., imaging data) back to a company. Once deployed in the field, the APS performance evaluation framework can evaluate the quality of NAPS by employing reformatted data based on high-resolution APS outputs and by employing generative AI to assess the quality of APS outputs.

In various embodiments, non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., performance evaluation model 110, auto-positioning component 112, image generation component 202, data selection component 204, image reformatting component 206, image evaluation component 208, computation component 210, training component 212 and output component 214) to perform one or more actions. In one or more embodiments, memory 106 can store computer-executable components (e.g., performance evaluation model 110, auto-positioning component 112, image generation component 202, data selection component 204, image reformatting component 206, image evaluation component 208, computation component 210, training component 212 and output component 214).

System 102 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 102 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 102 can reside in the cloud, and/or can reside locally in a local computing environment (e.g., at a specified location(s)).

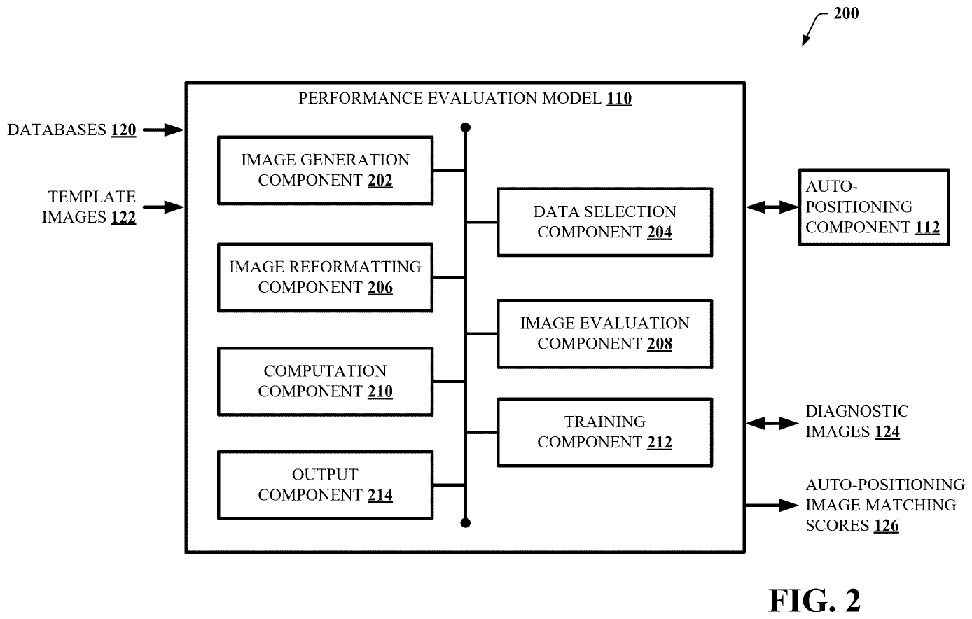

In various embodiments, system 102 can be an APS performance evaluation system that can comprised performance evaluation model 110 and auto-positioning component 112, in addition to processor 104, memory 106 and bus 108, wherein auto-positioning component 112 can be an APS whose performance is to be evaluated. As illustrated in FIG. 2, in various embodiments, performance evaluation model 110 can comprise image generation component 202, data selection component 204, image reformatting component 206, image evaluation component 208, computation component 210, training component 212 and output component 214.

In various embodiments, performance evaluation model 110 can be a generative AI model that can provide an APS performance evaluation framework to evaluate the performance of APS. For example, in various embodiments, image generation component 202 can generate diagnostic images 124 by employing an APS, wherein diagnostic images 124 can comprise one or more diagnostic images. For example, in various embodiments, data selection component 204 can select one or more datasets from databases 120, wherein databases 120 can comprise a plurality of databases of clinical images generated on the field (i.e., field data generated at a hospital, clinic, laboratory or another medical facility) via an imaging device such as an MRI scanner, a CT scanner or another type of scanner. The one or more datasets can be selected according to defined image criteria, and the one or more datasets can be employable to generate diagnostic images 124. For example, data selection component 204 can access and filter databases 120, such that the clinical images that cannot be processed by the APS can be filtered out. That is because APS can employ deep learning models that can only process clinical images that match certain image criteria. That is, only some of the data comprised in databases 120 can be processed by the APS. Accordingly, the one or more datasets acquired by filtering databases 120 can comprise clinical images that can be processed by the APS.

In various embodiments, upon generating the one or more datasets, image generation component 202 can generate diagnostic images 124 by employing the APS to process the clinical images comprised in the one or more datasets. For example, image generation component 202 can automatically execute auto-positioning component 112, wherein auto-positioning component 112 represents an APS that can process the clinical images from the one or more datasets to generate diagnostic images 124. In various embodiments, the APS can generate prescription plans for the one or more diagnostic images, wherein a prescription plan refers to a set of parameters (e.g., target anatomy, angles, distances, patient position, etc.) automatically generated by the APS to accurately position an entity (e.g., a patient) for imaging scans (e.g., MRI, CT, etc.). Diagnostic images 124 can comprise one or more diagnostic images that can be generated by the APS or generated by reformatting non-reformatted outputs of an imaging device (e.g., an MRI scanner, a CT scanner, etc.). Reformatted outputs refer to diagnostic images that are adjusted post-scanning on an imaging device to create optimized views of one or more anatomical sections. Non-reformatted outputs refer to raw scans from an imaging device without additional image processing. Some APS can directly generate reformatted diagnostic images, whereas other APS can generate non-reformatted outputs comprising diagnostic images not acquired along a desired anatomical landmark or plane (i.e., without additional image processing). For example, some APS can generate diagnostic images representative of an anatomical landmark, wherein such diagnostic images can represent reformatted diagnostic images. On the contrary, some APS can generate outputs that are not acquired along a defined anatomical landmark or plane. That is because, in some cases, an APS can have a format wherein the APS can prospectively generate reformatted diagnostic data internally (i.e., during the image acquisition process), whereas in other cases, the outputs of an imaging device can be retrospectively reformatted (i.e., after the imaging data has been acquired). For example, APS for MR can generate multi-planar diagnostic images directly, whereas APS for CT typically do not have the capability to generate multi-planar diagnostic images. In some cases, it can be possible to adjust/tilt the positioning of an entity being imaged with a CT scanner to generate the desired outputs (e.g., correct plane view, etc.). However, the imaging data generated by a CT APS typically undergo high-quality reformatting because the imaging data does not comprise diagnostic images acquired along the desired reference planes. In general, APS can be configured differently for different systems. APS for MR can prospectively generate reformatted diagnostic images or generate outputs that are retrospectively reformatted, whereas APS for CT typically generate outputs that are retrospectively reformatted. In various embodiments, given a defined format for the template images and diagnostic images 124 that can be compared to the template images, performance evaluation model 110 can be provided as a cloud-based solution or be employed as an office/model operations (ModelOps) solution.

An APS can generate a plane equation or a geometrical object/geometrical model/prescription geometries that can be generated via a prescription feature of the APS to correctly align an anatomy with standard anatomical planes. A plane equation can describe an auto-positioning plane based on which clinical images comprised in the one or more datasets obtained from databases 120 would have been acquired in the field, had the clinical images been processed in the field via auto-positioning. Based on the plane equation, an MRI scan, for example, can be sliced for certain views. In various embodiments, a similarity can also be established between the output of one prescription geometry and another prescription geometry to determine whether a geometry is good. In various embodiments, APS outputs that do not comprise reformatted diagnostic images can be retrospectively reformatted by employing high-dimensional data, wherein the retrospective reformatting can generate reformatted diagnostic images. For example, if diagnostic images 124 comprise non-reformatted outputs, then diagnostic images 124 can be further processed by image reformatting component 206, wherein image reformatting component 206 can transform respective non-reformatted outputs of the non-reformatted outputs into respective reformatted diagnostic images by employing a multi-planar reformatting tool to process the non-reformatted outputs. For example, upon acquiring the plane equation, the high-resolution outputs (i.e., anatomical scans) from an imaging device can be reformatted by image reformatting component 206. The resulting reformatted diagnostic images can then be directly compared to template images to generate auto-positioning image matching scores 126.

In various embodiments, image evaluation component 208 can generate, based on the defined image criteria, respective auto-positioning image matching scores for respective diagnostic images comprised in diagnostic images 124 by comparing the respective diagnostic images with respective sets of template images. For example, image evaluation component 208 can compare the respective diagnostic images with respective sets of template images comprised in template images 122 to generate auto-positioning image matching scores 126. More specifically, image evaluation component 208 can compare each diagnostic image with a relevant set of template images comprised in template images 122 to generate an auto-positioning image matching score for the diagnostic image. In one or more embodiments, template images 122 can be identified and selected by data selection component 204 from a set of pre-existing good quality images. It should be appreciated that, in one or more embodiments, template images 122 can be comprised within system 102, such as within memory 106 or another storage device not illustrated in FIG. 1. In various embodiments, image evaluation component 208 can employ a set of FMs and/or a ViT (e.g., an FM/ViT-based APS fidelity tool) to generate the respective auto-positioning image matching scores. For example, to compare a diagnostic image comprised in diagnostic images 124 with a template image comprised in template images 122, a set of FMs and a ViT can be employed to extract a first set of features from the template image and extract a second set of features from the diagnostic image. Thereafter, the set of FMs and the ViT can compute a similarity score based on the first set of features and the second set of features, wherein the similarity score can indicate a degree of similarity between the diagnostic image and the template image. For example, the set of FMs and the ViT can compute a cosine similarity score based on the first set of features and the second set of features, wherein the cosine similarity score can indicate a degree of similarity between the diagnostic image and the template image. The cosine similarity score can represent one type of evaluation metric. For example, in some embodiments, metrics other than the cosine similarity score (e.g., Euclidean distance, Manhattan distance, Jaccard similarity, etc.) can be employed to compare the template image with the diagnostic image. In one embodiment, image evaluation component 208 can convert the cosine similarity score (or another evaluation metric) to an image evaluation score corresponding to the diagnostic image. In another embodiment, image evaluation component 208 can employ the cosine similarity score (or another evaluation metric) itself at the image evaluation score corresponding to the diagnostic image. Auto-positioning image matching scores 126 thus generated can indicate performance of the APS in diagnostic imaging.

In various embodiments, output component 214 can triage auto-positioning image matching scores 126, and output component 214 can output auto-positioning image matching scores 126 and results of the triaging to a dashboard of a device (e.g., desktop computer, laptop, tablet, smartphone, etc.) accessible to a clinical SME. The clinical SME can review auto-positioning image matching scores 126 and provide feedback on the performance of the APS (e.g., an APS AI model). In various embodiments, image evaluation component 208 can also perform majority voting based on the cosine similarity scores (or other metrics) corresponding to the respective diagnostic images to determine whether the respective diagnostic images contain metal. In various embodiments, computation component 210 can compute tolerance values based on the respective auto-positioning image matching scores, wherein the tolerance values can be employable to define image quality metrics for APS. In various embodiments, the results of the majority voting and the tolerance values can also be output by output component 214 to the dashboard. Thus, in various embodiments, performance evaluation model 110 can provide a dashboarding mechanism, wherein performance evaluation model 110 can be employed as a system that can generate a dashboard or an generate an external site.

In various embodiments, performance evaluation model 110 can be trained by training component 212. There can be multiple ways of training performance evaluation model 110. For example, in an embodiment, training component 212 can access feedback provided by a clinical SME on the outputs generated by an APS to train performance evaluation model 110. For example, the clinical SME can evaluate a diagnostic image generated by performance evaluation model 110 and provide verbal feedback on the diagnostic image. The feedback can comprise information such as the clinical SME's interpretation of the diagnostic image and of the performance of the APS, comparison of clinical features in the diagnostic image, diagnostics descriptions, corrections, etc. Such verbal feedback can be captured via by a speaker, microphone or other device, recorded, converted to a text format by a software and stored in computer memory. The feedback in the text format can be accessed by training component 212 and employed as training data to train performance evaluation model 110. This manner of training can also speed up the training time which can be very large if, for example, one expert is employed to train other humans.

In another embodiment, training component 212 can perform a more traditional form of training an AI model, wherein the training data can comprise manual feedback and annotations from clinical SMEs, and training the performance evaluation model 110 on the training data can comprise minimizing the loss function of performance evaluation model 110.

In yet another embodiment, an existing pre-canned model can be trained by training component 212 on clinical features to evaluate the performance of an APS. Such a per-canned model can be trained to generate performance evaluation model 110. For example, instead of training performance evaluation model 110 from scratch, a large pre-canned model (also known as an FM) can be employed. Such a model can comprise rich features that, while they may not be able to perform all the tasks involved in evaluating the performance of the APS, can comprise semantic representations that can be suitable (e.g., good enough) for further training. In some embodiments, a contrast learning model or smaller NLPs can be also trained by training component 212 to predict whether reformatted diagnostic images are similar to template images.

In various embodiments, training component 212 can also re-train the APS (e.g., auto-positioning component 212). In various embodiments, training component 212 can access feedback provided by a clinical SME on the outputs generated by an APS, at a dashboard, to re-train the APS. For example, in one or more embodiments, the clinical SME can update the gold standard planes of the APS based on the dashboard evaluation. Thereafter, the failure cases identified by the clinical SME can be added by training component 212 to an APS model training pool, and the APS can be updated by re-training the APS on the APS model training pool. In some embodiments, the clinical SME can evaluate a diagnostic image generated by the APS and provide verbal feedback on the diagnostic image. The feedback can comprise information such as the clinical SME's interpretation of the diagnostic image and of the performance of the APS, comparison of clinical features in the diagnostic image, diagnostics descriptions, corrections, etc. Such verbal feedback can be captured via by a speaker, microphone or other device, recorded, converted to a text format by a software and stored in computer memory. The feedback in the text format can be accessed by training component 212 and employed as training data to periodically re-train the APS. This manner of training can also speed up the training time which can be very large if, for example, one expert is employed to train other humans.

Thus, in various embodiments, performance evaluation model 110 can provide a generative AI-based APS performance evaluation framework to evaluate the performance of APS as well as to re-train the APS. Typically, APS such as the AIRx™ suite of applications by GEHC for MRI scanning employ AI-based features to generate automated, AI-based prescriptions/intelligent slice prescriptions of anatomies.

Existing methods and techniques to evaluate such APS outcomes comprise acquiring clinical feedback from customers or to have the APS outcomes evaluated by a radiologist, technician, or another clinical SME. For example, the automated prescription feature of an APS can be executed to generate diagnostic images along a prescribed anatomical landmark or plane, and the clinical SME can provide feedback on the diagnostic images. For example, the clinical SME can employ certain criteria to determine whether a prescription generated by an APS is good and well aligned. However, this process is manual and tedious, and is applied across modalities such as MRI, CT, etc. More specifically, current method and approaches to evaluate the performance of an APS involve efforts from clinical SMEs to label images (either at acquisition stage or by employing reformatted images). Such labeling is mainly limited to volunteers. Additionally, there is potential for variability in the assessment of APS performance based on the use of thumb rules or familiarity of a clinical SME with the anatomy. Field feedback is available only if a site complains about the performance of the APS or requests such feedback, and complete holistic feedback for the performance of an APS is missing. Moreover, the field feedback is available only for anatomical landmarks scanned at the site, and feedback is generated only for anatomical markers that may have been prescribed at the site.

On the contrary, performance evaluation model 110 can automate, via generative AI, the evaluation procedure employed by a clinical SME. For example, performance evaluation model 110 can evaluate the performance of the APS by evaluating, via certain similarity metrics and generative AI, the defined image criteria employed by the APS, wherein images from a database are compared to relevant template images. For example, the APS performance evaluation approach employed by performance evaluation model 110 can automate the application of objective criteria for the assessment by employing a combination of iMPR and FM/ViT based assessments, leverage a large pool of already available Sherlock and external databases to perform objective evaluation during the development cycle of an APS and enable a non-iterative/one-shot step and shoot development cycle. Additionally, performance evaluation model 110 can be bundled as a ModelOps framework to be leveraged at a location to assess the performance of AI models by employing real-world data and reporting the performance, provide exact measures of tolerance limits for APS rather than heuristically determined limits and give an idea of site-specific or tech-specific tolerance/variabilities in prescriptions for anatomies, wherein such information can assist with defining Critical-to-Quality (CTQ) parameters for model testing. The automatic execution of APS in the various embodiments herein can allow all available APS-compatible data to be employed. Additional aspects of one or more of these customer/patient benefits are described with reference to FIG. 2.

FIG. 2 illustrates a block diagram of an example, non-limiting system 200 that can employ generative AI to evaluate the performance of an APS in accordance with one or more embodiments described herein. Repetitive description of like elements and/or processes employed in respective embodiments is omitted for sake of brevity.

With continued reference to FIG. 1, non-limiting system 200 illustrates the system of performance evaluation model 110 comprising image generation component 202, data selection component 204, image reformatting component 206, image evaluation component 208, computation component 210, training component 212 and output component 214.

As previously mentioned, in various embodiments, performance evaluation model 110 can enable a single-shot large scale evaluation of the performance of an APS during development of the APS. Such evaluations can reduce the length of the development cycle of the APS by providing a field-like robustness in assessment of the APS performance during the development. Additionally, the evaluation framework provided by performance evaluation model 110 can eliminate the need for marking ground truth data for new unseen data. Further, for any retrospective data from a site (e.g., a hospital, a clinic, laboratory or another medical facility), performance evaluation model 110 can enable a quick review of anatomical landmarks provided by the APS, without limiting the review to only the anatomical landmarks selected by an end entity (e.g., hardware, software, machine, AI, neural network, user). For example, a medical practitioner can indicate that a patient's hippocampus is not functioning as expected, but with the evaluation framework of performance evaluation model 110, the patient can be scanned for other landmarks offered by a Brain MR APS in addition to the hippocampus.

In an embodiment, performance evaluation model 110 can be offered as an on-site feature as part of an APS ModelOps suite with the reporting of metrics enabled. Further, performance evaluation model 110 can ascertain CTQ metrics and tolerance levels of APS system errors. For example, in diagnostic imaging, CTQ metrics are often employed to ensure accurate anatomical positioning, such as ensuring that a plane is dividing an anatomy symmetrically, etc. Diagnostic images generated by APS are often manually evaluated by a clinical SME according to such criteria. In the embodiments of the present disclosure, performance evaluation model 110 can learn such criteria and employ them to evaluate performance of the APS.

The automated testing method provided by performance evaluation model 110 to test the performance of an APS on a large variety of data can ensure regulatory compliance for the APS. For example, regulatory pressure on AI developers is mounting, and regulatory agencies are requesting AI developers to provide evidence for continuous monitoring of AI software. Performance evaluation model 110 can make the APS more trustworthy to regulatory agencies. Other benefits of performance evaluation model 110 can include a reduction in the image reading time spent by a clinical SME to generate image labels and a reduction in fatigue and fatigue-induced errors by the clinical SME. Further, performance evaluation model 110 can be employed to derive analytics even without prior instrumentation in an APS deployed in the field.

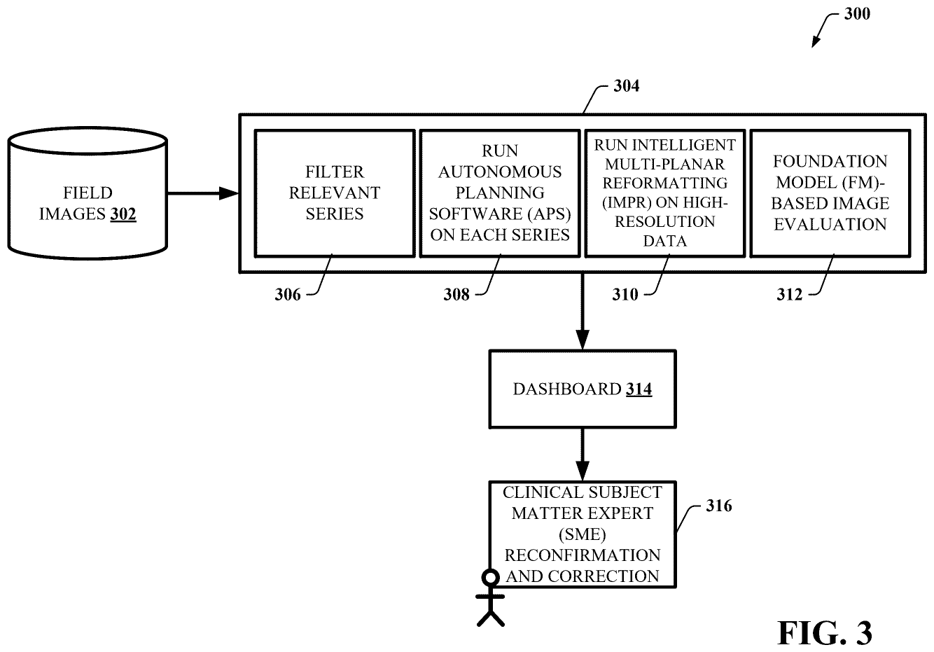

FIG. 3 illustrates a flow diagram of an example, non-limiting method 300 that can employ generative AI to evaluate the performance of an APS in accordance with one or more embodiments described herein. Repetitive description of like elements and/or processes employed in respective embodiments is omitted for sake of brevity.

Non-limiting method 300 illustrates the automatic workflow/pipeline of the evaluation framework provided by performance evaluation model 110 to evaluate the performance of an APS, generate an assessment based on the evaluation and enable a review of the evaluation. In this regard, non-limiting method 300 can be employed to automatically execute the APS on clinical images comprised in one or more datasets, generating auto-positioning image matching scores 126 by employing one or more FMs and vision transformer ViTs on diagnostic images (e.g., diagnostic images 124), outputting the auto-positioning image matching scores to a dashboard, and accessing/collecting feedback based on the review from a clinical SME on the performance of performance evaluation model 110.

For example, with continued reference to FIGS. 1 and 2, field images 302 can represent clinical images from the field/Installed Base (IB) (i.e., field data generated at a hospital, clinic, laboratory or another medical facility) and comprised in databases 120. Herein, IB indicates MRI systems deployed in the field. For example, field images 302 can comprise clinical images from one or more field image data sources such as the Sherlock database. At 306 of block 304, data selection component 204 can filter relevant series (i.e., datasets) of clinical images comprised in field images 302 by employing validation criteria (i.e., defined image criteria) for the filtering. For example, data selection component 204 can filter field images 302 to find APS-relevant exams. For the AIRX™ suite of applications, the results of the filtering can comprise localizer series that meet the validation criteria and higher-resolution 3D series. At 308, image generation component 202 can run APS on each series of clinical images obtained from field images 302. The output of the APS can comprise high-resolution outputs. In one or more embodiments, if the high-resolution outputs thus generated are non-reformatted diagnostic images, then at 310, image reformatting component 206 can run the iMPR tool on the non-reformatted diagnostic images to generate reformatted diagnostic images. For example, the output of the APS can be a volume, and the iMPR tool can generate intelligent multi-planar reformats of the volume by employing marker planes and re-slicing the volume with respect to computed anatomical planes.

At 312, image evaluation component 208 can perform a foundation model-based image evaluation of the diagnostic images based on the defined image criteria. For example, image evaluation component 208 can employ defined image criteria-based parameters such as contiguity, symmetry, etc. per anatomical landmark to evaluate the reformatted diagnostic images, and thereby evaluate the performance of the APS. Based on the evaluation, image evaluation component 208 can automatically generate auto-positioning image matching scores 126, wherein auto-positioning image matching scores 126 can comprise respective images quality/evaluation scores for respective diagnostic images. In various embodiments, output component 214 can triage and output auto-positioning image matching scores 126 to dashboard 314. At 316, the outputs to dashboard 314 can be evaluated by a clinical SME (e.g., radiologist, technician, or another clinical SME), and the clinical SME can provide feedback and corrections via the iMPR tool. For example, the clinical SME can indicate whether they agree with the evaluation of image evaluation component 208, whether somethings are missing, etc. In one or more embodiments, dashboard 314 can also be provided by output component 214.

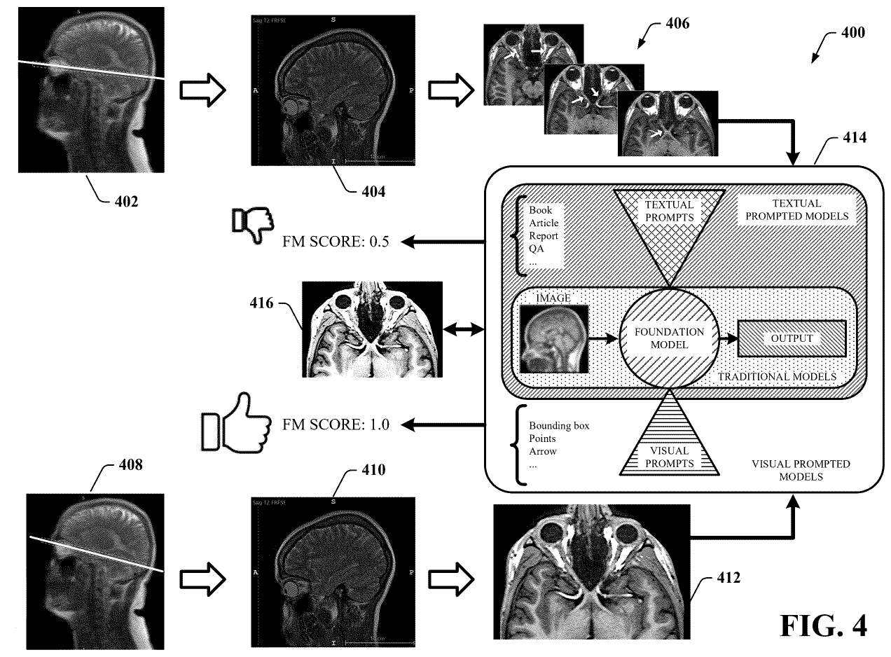

FIG. 4 illustrates a flow diagram of an example, non-limiting method 400 that can employ generative AI to evaluate the performance of an APS in accordance with one or more embodiments described herein. Repetitive description of like elements and/or processes employed in respective embodiments is omitted for sake of brevity.

With continued reference to the embodiments of FIGS. 1-3, image 402 illustrates a diagnostic image of a brain showing an optic nerve. The diagonal line in image 402 illustrates an incorrect optic nerve plane prescribed by a brain APS. Image 402 illustrates a high-resolution output of the brain APS, and image 404 can represent the output of intelligent multi-planar reformatting performed on image 402 by the iMPR tool. Images 406 illustrate reformatted image slices generated by the iMPR tool. The arrows in images 406 show breaks along the image slices, indicating that there is no contiguous visualization of the optic nerve.

Similarly, image 408 illustrates another diagnostic image of the brain showing an optic nerve. The diagonal line in image 408 illustrates a correct optic nerve plane prescribed by the brain APS. Image 408 can represent a high-resolution output of the brain APS, and image 410 can represent the output of intelligent multi-planar reformatting performed on image 408 by the iMPR tool. Image 412 illustrates a reformatted image slice generated by the iMPR tool. The arrows in image 412 show a contiguous visualization of the optic nerve in a single slice.

Images 406 can be evaluated by image evaluation component 208 against template image 416 to evaluate performance of the brain APS, wherein template image 416 illustrates a desirable/good visualization of an optic nerve. For example, at 414, image evaluation component 208 can employ an FM/ViT-based APS fidelity tool to evaluate images 406. Evidently, images 406 do not match template image 416. For example, images 406 do not show the entire optic nerve in a single slice. Instead, images 406 show the optic nerve as split across three different image slices, such that none of the individual image slices of images 406 show the entirety of the optic nerve. As a result, the FM/ViT-based APS fidelity tool can generate an FM score (i.e., an auto-positioning image matching score) of 0.5 for the brain APS based on images 406. Similarly, at 414, image evaluation component 208 can employ the FM/ViT-based APS fidelity tool to evaluate image 412. As evident, image 412 shows the entire optic nerve in a single shot. For example, the optic nerve can be seen from the beginning (i.e., from the eye) all the way up to the optic chiasm. Accordingly, the FM/ViT-based APS fidelity tool can generate an FM score (i.e., an auto-positioning image matching score) of 1.0 for the brain APS based on image 412.

In some cases, multiple template images can be provided to the FM/ViT-based APS fidelity tool. For example, image evaluation component 208 can load five different template images into the FM/ViT-based APS fidelity tool. For example, image evaluation component 208 can load one template image for the optic nerve, another template image for the hippocampus, a third template image for another anatomical landmark, and so on, into the FM/ViT-based APS fidelity tool. The optic nerve template image can be similar to template image 416 and show what a good visualization of an optic nerve should look like. The FM/ViT-based APS fidelity tool can compare the outputs of the iMPR tool with the relevant template images to determine whether the outputs match the relevant template images. In this regard, the FM/ViT-based APS fidelity tool can be a software programmed to act as a good matcher for diagnostic images, and so long as the relevant template images are provided to the FM/ViT-based APS fidelity tool, the FM/ViT-based APS fidelity tool can perform the image matching and identify diagnostic images that match and that don't match their corresponding template images.

Thus, performance evaluation model 110 can be automatically programmable because performance evaluation model 110 can evaluate outputs of different APS (e.g., brain APS, heart APS, etc.) by providing only the relevant template images (e.g., brain template images, cardiac template images, etc.) to the FM/ViT-based APS fidelity tool. For example, during a first evaluation cycle, performance evaluation model 110 can be employed to evaluate the performance of a brain APS, during a second evaluation cycle, performance evaluation model 110 can be employed to evaluate the performance of a cardiac APS, and so on, with the only input from an entity (e.g., hardware, software, machine, AI, neural network and/or user) being the template images employable for each APS. On the contrary, existing techniques to evaluate the performance of an APS can involve independent evaluations for each APS. For example, each APS can be evaluated by an expert having the associated skill set, etc. since one expert is most likely to be skilled in only one area of medicine. Such a manual process can increase the life cycle of the performance evaluation, whereas embodiments of the present disclosure can reduce the life cycle.

In various embodiments, output component 214 can output the results (e.g., FM scores) of the FM/ViT-based APS fidelity tool to a dashboard (e.g., dashboard 314). Additionally, output component 214 can output a visual flow of the automatic workflow employed by performance evaluation component 110, on the dashboard. In one or more embodiments, the FM/ViT-based APS fidelity tool can also show “thumbs up” or “thumbs down” indicators to indicate which diagnostic images match their relevant template images and which ones do not. Output component 214 can also output such indicators along with auto-positioning image matching scores 126 to the dashboard. In an embodiment, the outputs displayed by output component 214 at the dashboard can be further assessed by a SME.

In one or more embodiments, performance evaluation model 110 can be located at a central location and the FM/ViT-based APS fidelity tool can be deployed from the central location to one or more secondary locations such as medical facilities. For example, the FM/ViT-based APS fidelity tool can be made available to a hospital as a cloud-based service to evaluate performances of one or more APS employed by the hospital. The FM/ViT-based APS fidelity tool can evaluate the performance of the one or more APS and generate auto-positioning image matching scores for diagnostic images (e.g., diagnostic images 124) generated at the hospital. In such embodiments, the imaging data from a medical facility can remain with the medical facility, but the FM/ViT-based APS fidelity tool can match the imaging data against relevant image templates to generate “thumbs up” or “thumbs down” indicators based on the performance of the APS employed by the medical facility, and such indicators can be viewed by the central location as well as the medical facility. The FM/ViT-based APS fidelity tool can also generate text information based on the indicators. For example, the FM/ViT-based APS fidelity tool can generate text information describing an incorrect positioning or poor image quality of an optic nerve in a diagnostic image. Such feedback can indicate that, for example, the APS is not being employed correctly by the medical facility or that the APS is not processing the diagnostic images correctly. In this case, an entity (e.g., hardware, software, machine, AI, neural network and/or user) from the central location can reach out to the medical facility with the feedback from the FM/ViT-based APS fidelity tool to inform the medical facility that their APS has issues (e.g., the APS is not loading properly, the APS is biased, etc.). As a result, a program manager or another entity at the medical facility can choose to check for issues and biases inherent within the APS, review whether clinical images with the incorrect format are being input to the APS, check for faulty software parameters, etc.

In one or more embodiments, APS can be deployed as part of ModelOPS at one or more locations/sites such as medical facilities, and performance evaluation model 110 located at a central location can collect information about the performance of the APS via the FM/ViT-based APS fidelity tool. Thus, the FM/ViT-based APS fidelity tool can be employed internally (e.g., at the central location) or externally (e.g., at one or more medical facilities). In some embodiments, the central location can also be a medical facility such as a hospital, clinic, etc. In one or more embodiments, imaging data from multiple reputable institutions such as medical colleges can be accessed by training component 212. Such imaging data can typically be high quality data or be attributed high confidence levels because reputable institutions are geared towards higher quality content. Training component 212 can pool such high-quality imaging data from different institutions to generate a training dataset and employ the training dataset to train performance evaluation model 110. In an embodiment, imaging data with high fidelity collected from reputable institutions can also be employed as template images by the FM/ViT-based APS fidelity tool to assess performance of an APS.

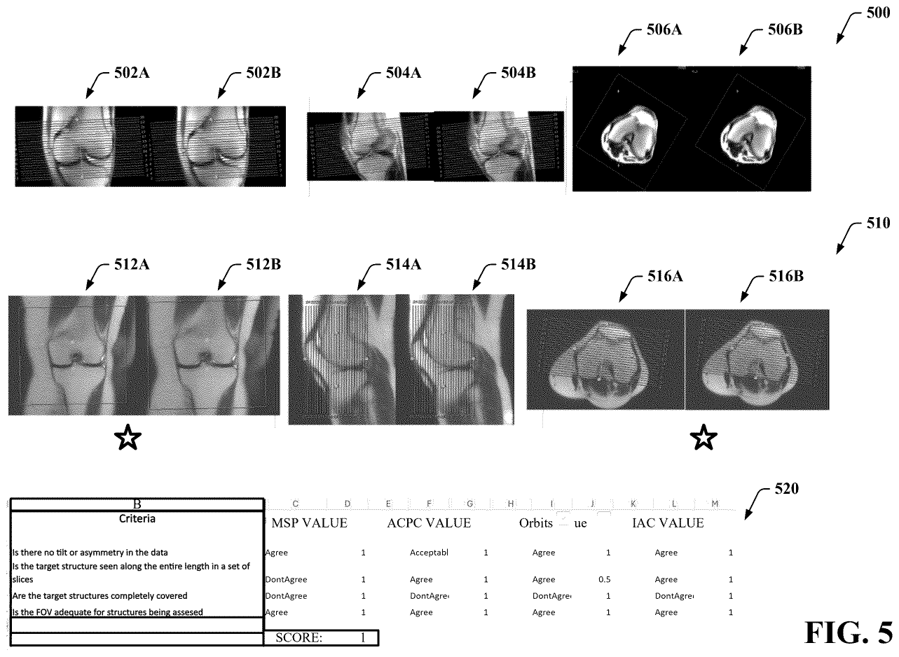

FIG. 5 illustrates example, non-limiting images 500, 510, 520 associated with the performance evaluation of an APS. Repetitive description of like elements and/or processes employed in respective embodiments is omitted for sake of brevity.

FIG. 5 is intended to highlight the advantages of the embodiments of the present disclosure over existing techniques. In this regard, non-limiting images 500 and 510 illustrate results associated with the performance evaluation of an APS via existing techniques. Non-limiting images 500 and 510 illustrate the case by case evaluation of images of a human knee generated on a scanner via a GRx application for a limited volunteer pool.

Images 502A, 504A and 506A illustrate axial, heavy rotation GEM medium flex images (exam 8809) that were generated via the AIRx™ suite of applications, and images 502B, 504B and 506B illustrate their manual assessments. Images 502A and 502B show a good cor viewport positioning, images 504A and 504B show a good sag viewport positioning and images 506A and 506B show a good ax viewport positioning. Ironically, with the heavy rotation, the axial prescription of the APS did not shift the image slices more laterally as did the routine knee position.

Similarly, images 512A, 514A and 516A illustrate cor knee images of the femur (exam 8810) that were generated via the AIRx™ suite of applications using time delay integration (TDI) with anti-aliasing (AA) and 16 channels (16ch), and images 512B, 514B and 516B illustrate their manual assessments. The star symbol for image 512B indicates that the cor viewport positioning is too medial by about ˜12 millimeters (mm). Likewise, the star symbol for image 516B indicates that the ax viewport positioning is too medial by about ˜12 mm.

However, as stated elsewhere herein, manual APS feedback mechanisms are often very iterative and slow. For example, non-limiting image 520 illustrates a sample evaluation sheet provided to clinicians as part of the development of the AIRx™ APS. The clinicians employed the AIRx™ data acquired for the brain to painstakingly assess the data and evaluate the performance of the APS, manually. Existing techniques for the performance evaluation of APS typically employ such data sheets in Excel® or another program in which several visual criteria (e.g., brain, mid-sagittal plane (MSP), symmetric anterior commissure-posterior commissure (AC-PC), etc.) are listed. The objective visual criteria employed for various anatomical landmarks are listed inside the box at the left-hand side of non-limiting image 520.

Table 1 additionally lists individual visual criteria for assessment of different anatomical landmarks in diagnostic images generated by APS. Depending on whether any visual criteria are missing, a radiologist, technician or another clinical SME can mark such data with points (e.g., 1 point, 0.5 points, etc.) to evaluate the performance of the APS. For example, medical practitioners often need to know what the anterior cruciate ligament (ACL) in a knee looks like, etc. Such evaluation is very manual and time consuming even though the visual criteria presented in the data are identical to the defined image criteria (e.g., symmetric visibility of the brain in a single image, etc.) employed by the FM/ViT-based APS fidelity tool to perform image matching. On the contrary, in one or more embodiments described herein, an entity (e.g., hardware, software, machine, AI, neural network and/or user) can generate template images and load the template images as a cassette in a computing system, wherein the template images can be accessible to the FM/ViT-based APS fidelity tool. The FM/ViT-based APS fidelity tool can automatically evaluate, based on the template images, diagnostic images generated by the APS and/or reformatted by an iMPR tool, as described with reference to FIG. 1.

TABLE 1
Visual criteria/defined image criteria

| Brain: | Knee: | |
|---|---|---|
| MSP: Symmetric data | Sagittal: | |
| AC-PC: Visible in single section | 1. | ACL seen in single slice [optional]. |
| ON: Entire set of optic nerve | 2. | Cartilage and ligament completely |
| and radiation seen in a set of | | covered. |
| slices and bilaterally | | |
| IAC: Entire length of eights | 3. | Structures beyond condoyle not |
| nerve and IAC visible in a single | | included. |
| section bilaterally | | |
| | Coronal: | |
| | 1. | Plane is perpendicular to condoyle |
| | | plane. |
| | 2. | Cartilage and ligament completely |
| | | covered. |
| | 3. | Structures beyond condoyle not |
| | | included. |
| | Axial: | |
| | 1. | Plane is along the joint line |
| | 2. | Upper pole of patela and head of |
| | | fibula is included. |
| | 3. | No additional tissues included. |

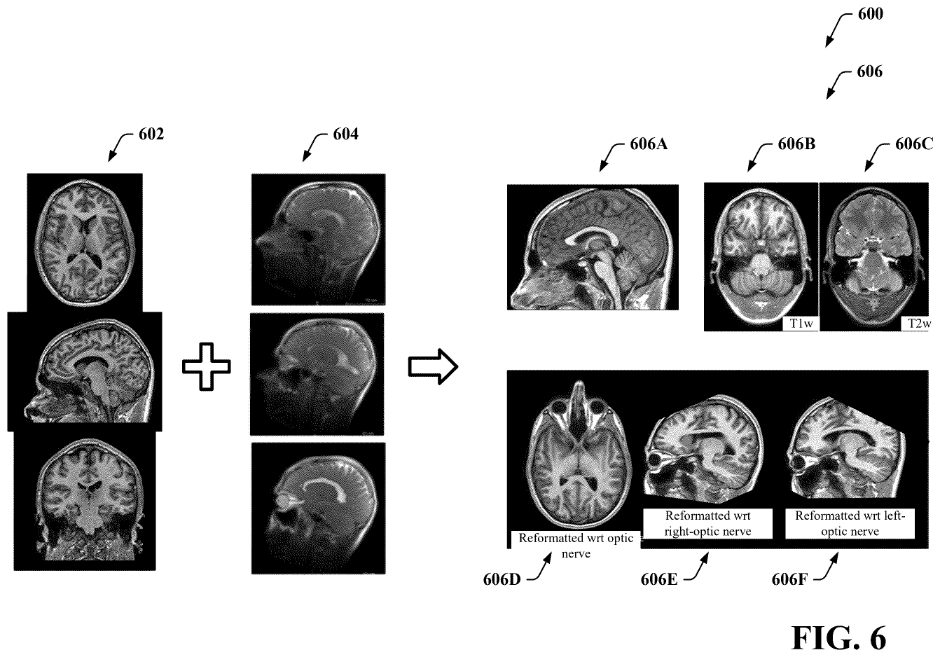

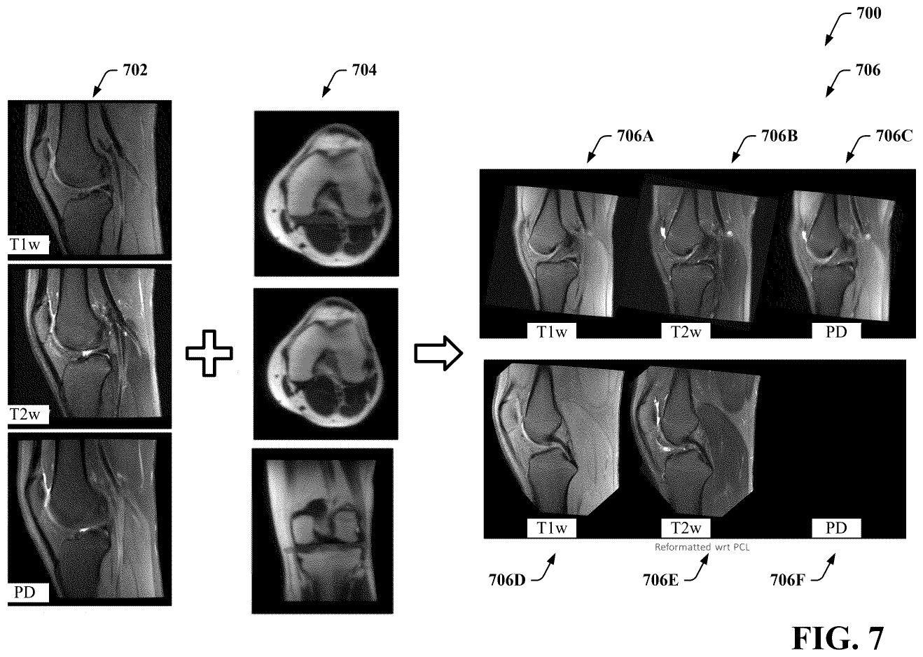

FIG. 6 illustrates a flow diagram of an example, non-limiting method 600 to show the use of APS to generate multi-planar images of a human brain, and FIG. 7 illustrates a flow diagram of an example, non-limiting method 700 to show the use of APS to generate multi-planar images of a human knee in accordance with one or more embodiments described herein. Repetitive description of like elements and/or processes employed in respective embodiments is omitted for sake of brevity.

With continued reference to the embodiments discussed thus far, recall that in one or more embodiments, if an APS does not have the ability to generate reformatted outputs, the non-reformatted outputs from the corresponding imaging device can be further processed by image reformatting component 206, wherein image reformatting component 206 can transform respective non-reformatted outputs into respective reformatted diagnostic images by employing an iMPR tool to process the non-reformatted outputs. Employing APS outputs to generate multi-planar outputs is a well-established, recognized and robust method, and the multi-planar reformatting capability of image reformatting component 206 is a standard and reliable technology.

In this regard, non-limiting method 600 illustrates multi-planar reformatting of diagnostic images of a brain generated by a brain APS, and non-limiting method 700 illustrates multi-planar reformatting of diagnostic images of a human knee generated by a knee APS. For example, in non-limiting method 600, images 602 represent high-resolution T1w images, and images 604 illustrate scan-plane masks from a brain APS. Upon reformatting, the brain APS outputs can generate images 606 comprising a diagnostic image reformatted with respect to an MSP (image 606A), diagnostic images reformatted with respect to the internal auditory canal (image 606B (T1w) and image 606C (T2w)) and diagnostic images reformatted with respect to the optic nerve (image 606D), the right optic nerve (image 606E) and the left optic nerve (image 606F).

Similarly, in non-limiting method 700, images 702 show high-resolution images (from top to bottom, T1w, T2w and PD), and images 704 illustrate scan-plane masks from a knee APS. Upon reformatting, the knee APS outputs can generate images 706 comprising images reformatted with respect to the ACL (image 706A (T1w), image 706B (T2w) and image 706C (PD)) and images reformatted with respect to the posterior cruciate ligament (PCL) (image 706D (T1w), image 706E (T2w) and image 706F (PD)).

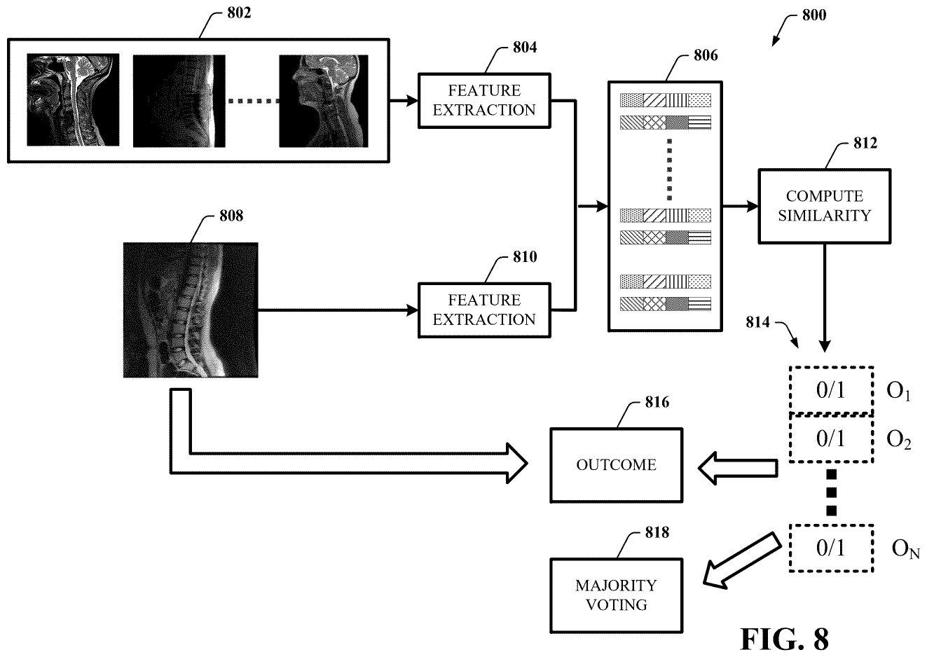

FIG. 8 illustrates a flow diagram of an example, non-limiting method 800 that can be employed by an algorithm to perform template-based matching of diagnostic images in accordance with one or more embodiments described herein. Repetitive description of like elements and/or processes employed in respective embodiments is omitted for sake of brevity.

Non-limiting method 800 illustrates the workflow of a sample algorithm that can be employed by an FM (e.g., FM/ViT-based APS fidelity tool) to perform the template-based image matching described in various embodiments herein. In one or more embodiments, more sophisticated/complex versions of algorithms can also be employed by the FM.

In non-limiting method 800, images 802 show sample template images N (e.g., from left to right, images C₁, C₂, . . . , C_{N}), and image 808 shows a query image. In various embodiments, the foundation model can perform template-based image matching to match image 808 with each image comprised in images 802. At 804, the foundation model can perform feature-extraction for each sample template image by employing a pre-trained DINO model to extract image features from each sample template image. Likewise, at 810, the foundation model can perform feature-extraction for the query image by employing a pre-trained DINO model to extract image features from the query image. At 806, the foundation model can create pairs of query image and template image features. For example, the foundation model can create pairs of image features, wherein a first set of image features belong to the query image (image 808) and wherein a second set of images features belong to a sample template image (images 802). In other words, the foundation model can pair the image features from the query image with the image features from each sample template image.

At 812, the foundation model can compute, based on the pairs of image features generated in the previous step, a similarity for each template image-query image pair, wherein the similarity can be computed in feature space. For example, the foundation model can compute a cosine-similarity for each template image-query image pair. The cosine-similarity for a template image-query image pair can be represented by a cosine-similarity score, wherein the cosine similarity score can be one (1) if cosine similarity (cos_sim)>α, and wherein α represents a threshold that can be employed to classify the query image as positive (i.e., good quality) or negative (i.e., poor quality). Exemplary cosine similarity scores for individual template image-query image pairs are illustrated at 814. In an embodiment, the cosine similarity scores for a diagnostic image such as image 808 can be converted to an auto-positioning image matching score for the diagnostic image. In another embodiment, a single cosine similarity score for a diagnostic image can be selected as the auto-positioning image matching score for the diagnostic image.

At 816, the outcomes of the foundation model can be output by output component 214 to a dashboard that can be accessible via a device (e.g., desktop computer, laptop, tablet, etc.). The outcomes can indicate whether image 808 (i.e., the query image) matches images 802 (i.e., the sample template images). For example, the outcome for image 808 can indicate that image 808 does not match images 802. In an embodiment, the cosine similarity scores can be output to the dashboard as auto-positioning image matching scores 126. In another embodiment, the cosine similarity scores can be employed by the foundation model to compute auto-positioning image matching scores 126 that can be output to the dashboard. In various embodiments, similarity metrics other than the cosine similarity score can also be employed by the FM to perform template-based image matching. In general, the FM can act as an image feature matcher that can employ various algorithms having various levels of complexities that can interpret different types of similarity scores.

In some embodiments, the set of template images comprised in images 802 can comprise metal. Accordingly, at 818, the foundation model can perform majority voting based on the template comparison outputs (e.g., cosine similarity scores, auto-positioning image matching scores 126, or other types of scores), wherein the majority voting can indicate whether the query image (i.e., image 808) comprises metal.

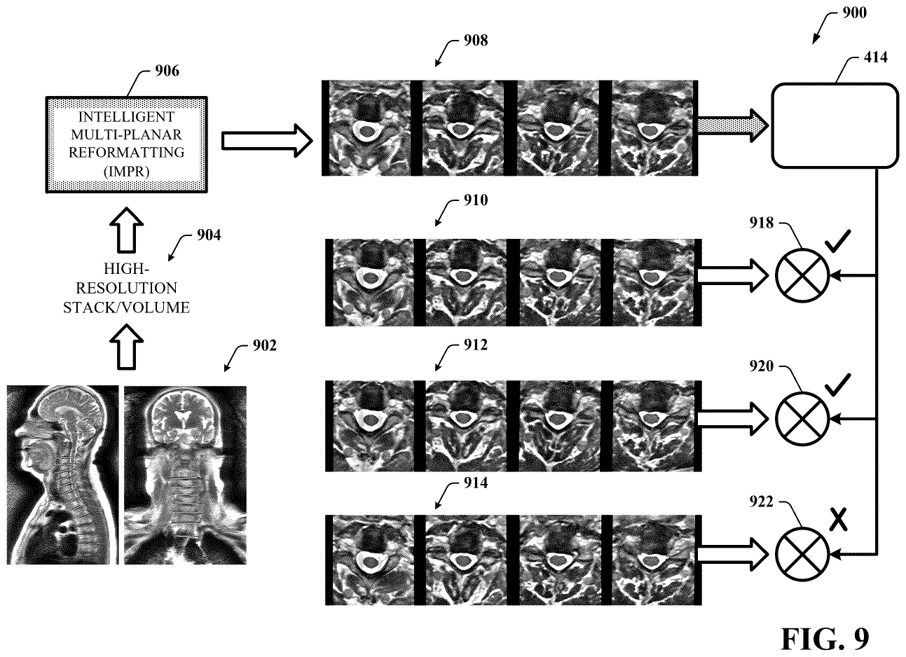

FIG. 9 illustrates a flow diagram of an example, non-limiting method 900 that can be employed by an algorithm to determine error tolerance limits for diagnostic images in accordance with one or more embodiments described herein. Repetitive description of like elements and/or processes employed in respective embodiments is omitted for sake of brevity.

Non-limiting method 900 illustrates how, in various embodiments, performance evaluation model 110 described with reference to FIG. 1 can act as a tool that can be employed to determine tolerance limits. In this regard, non-limiting method 900 illustrates a few exemplary diagnostic images of a sample anatomy that is shown on a single case. However, it should be noted that in practice, Nis large (e.g., above a certain threshold).

Tolerance limits correspond to the quality of diagnostic images generated by an APS and can define the acceptable error limits for the diagnostic images when compared with a set of relevant template images. For example, in practice, it is likely that a diagnostic image is not a 100 percent (100%) match with a template image, but it can be 95% match, a 90% match and so on. Additionally, the error limits can vary based on the use case, anatomical landmarks, the medical facility employing the APS and/or other factors. If a clinical SME (e.g., radiologist, technologist, etc.) is queried regarding the tolerance limit for a diagnostic image (e.g., “Which image quality is good enough for your task?), the clinical SME will typically provide a ballpark answer based on their training. For example, the clinical SME can say that errors are typically measured in terms of angulation errors measured in degrees; however, different clinical SMEs can provide different angulation error values. For example, one technologist can say that a 5 degree (5°) angulation error is permissible, whereas another technologist can say that a 4° or even a 6° angulation error is permissible. However, clinical SMEs cannot predict what the diagnostic image will look like, for example, with an angulation error of 5.5°. Thus, it is not possible to obtain clearly defined and standardized error values based on human observation.

Defined error values can be good image criteria that can be employed to assess diagnostic images. In various embodiments, computation component 210 can determine tolerance limits (e.g., angulation degree errors or other types of errors) for diagnostic images generated by an APS based on auto-positioning image matching scores 126 generated by image evaluation component 208. For example, computation component 210 can determine the tolerance limits for angulation errors in the diagnostic images generated by the APS. In various embodiments, the tolerance limits determined by computation component 210 can be employed to define image quality metrics and to analyze diagnostic images for different image criteria. For example, computation component 210 can indicate that an angulation error of up to 6° is permissible for a diagnostic image because up to this tolerance limit, the diagnostic image does not display significant differences in visual quality; however, an angulation error greater than 6° is not permissible. Thus, in various embodiments, given a good quality template image, the tolerance limits, and thereby acceptable objective criteria/defined image criteria can be determined for different error categories associated with a diagnostic image generated by an APS. Further, the tolerance limits can be determined without relying on human interpretation which can often be subjective. This eliminates variability and subjectivity in the tolerance limits.

In various embodiments, the tolerance limits determined by the FM/ViT-based APS fidelity tool can also assist medical facilities with regulatory compliance. For example, a hospital can justify their choice of tolerance limits for various image criteria to regulatory agencies or persons by presenting examples of diagnostic images having errors that exceed their tolerance limits as proof of poor-quality diagnostic images, etc.

In this regard, image 902 illustrates a diagnostic image of a spine generated by a multi-slice-multi-angle APS (Red=DL Pred, Green=ground truth (GT)). At 904, image generation component 202 can generate a high-resolution axial stack of diagnostic images generated by the APS, and at 906, an iMPR tool can reformat the diagnostic images comprised in the high-resolution stack. At 908, template images from ground truth data can be loaded into the FM/ViT-based APS fidelity tool. In FIG. 9, the FM/ViT-based APS fidelity tool is identified by the numeral 414 to represent the FM/ViT-based APS fidelity tool from FIG. 4. Additionally, the reformatted diagnostic images can be input to the FM/ViT-based APS fidelity tool to perform image matching, and the FM/ViT-based APS fidelity tool can generate auto-positioning image matching scores 126. Based on auto-positioning image matching scores 126, computation component 210 can compute tolerance limits for various defined image criteria. In an exemplary scenario, the reformatted diagnostic images can comprise an image criterion having a 3° error (as shown at 910), and the FM/ViT-based APS fidelity tool can generate, at 918, an auto-positioning image matching score of 0.99. In another exemplary scenario, the reformatted diagnostic images can comprise a 6° error (as shown at 912), and the FM/ViT-based APS fidelity tool can generate, at 920, an auto-positioning image matching score of 0.98. In yet another exemplary scenario, the reformatted diagnostic images can comprise a 12° error (as shown at 914), and the FM/ViT-based APS fidelity tool can generate, at 922, an auto-positioning image matching score of 0.9. In various embodiments, image evaluation component 208 can assess the auto-positioning image matching scores and determine that an acceptance cutoff for the auto-positioning image matching scores can be 0.95. Computation component 210 can employ this acceptance cutoff value for the auto-positioning image matching score to determine tolerance limits for the image criteria considered. For example, since the diagnostic images at 914 comprising a 12° error have an auto-positioning image matching score of 0.9 which is less than 0.95, computation component 210 can determine that the tolerance limits for the image criteria being considered can be 6°. That is, diagnostic images having an error greater than 6° for that image criteria should be unacceptable. In one or more embodiments, the acceptance cutoff can also be employed (e.g., by computation component 210 or another component of performance evaluation model 110) for triaging. For example, if a diagnostic image has an auto-positioning image matching score equal to or greater than the acceptance cutoff, that diagnostic image can be employed for triaging. Otherwise, the diagnostic image can not be employed for triaging.

Tolerance limits computed/determined by computation component 210 can be a more accurate method of assessing image quality. For example, CTQ parameters determined by a clinical SME (e.g., original CTQ parameters) can suggest that a 3° error can be tolerated for an image criterion, whereas the automated CTQ parameters determined by computation component 210 can determine that a 6° error can be tolerated for the image criterion. This can prevent diagnostic image from being incorrectly classified as unacceptable and promote an accurate evaluation of the APS.

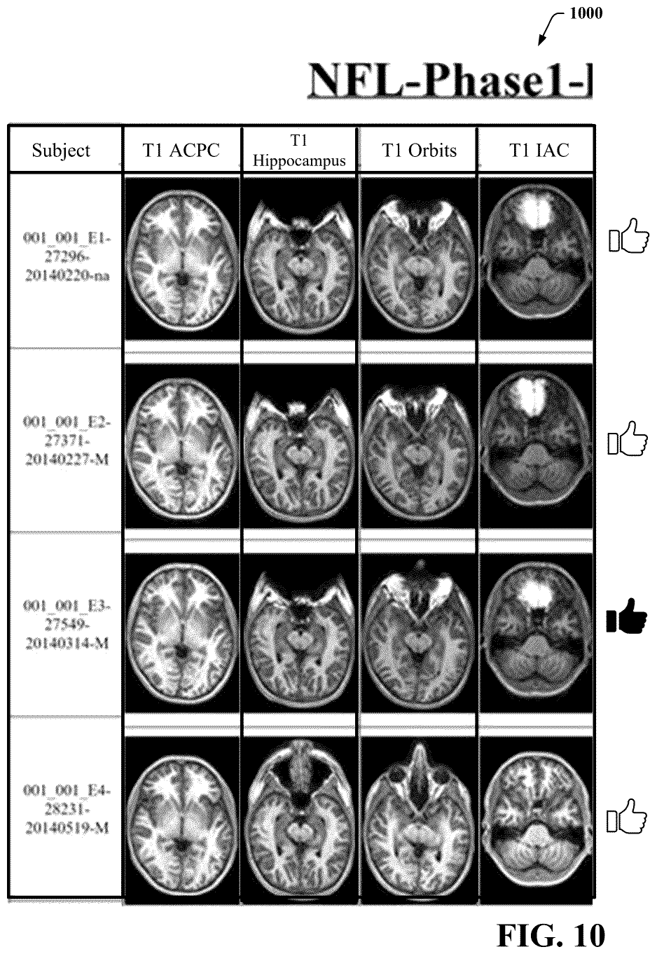

FIG. 10 illustrates a diagram of an example, non-limiting dashboard 1000 that can be employed in triaging in accordance with one or more embodiments described herein. Repetitive description of like elements and/or processes employed in respective embodiments is omitted for sake of brevity.

With continued reference to FIGS. 1-3, non-limiting dashboard 1000 is an example of an automated dashboard that can be provided by output component 214 for triaging, and non-limiting dashboard 1000 can be analogous to dashboard 314. In various embodiments, the data output by output component 214 to non-limiting dashboard 1000 can be validated by a clinical SME and any corrections provided by the clinical SME can be incorporated as feedback by training component 212 to train performance evaluation model 110.

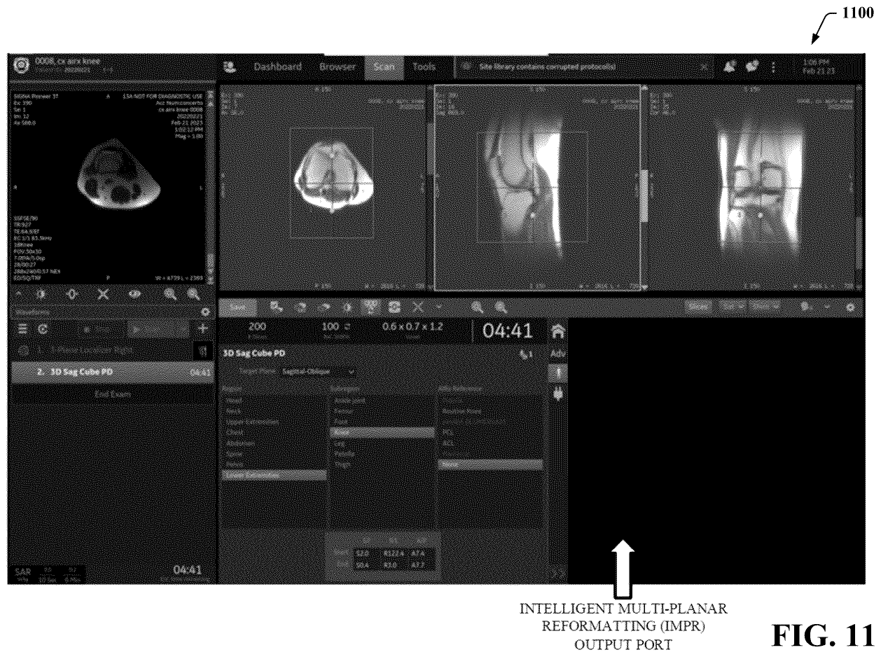

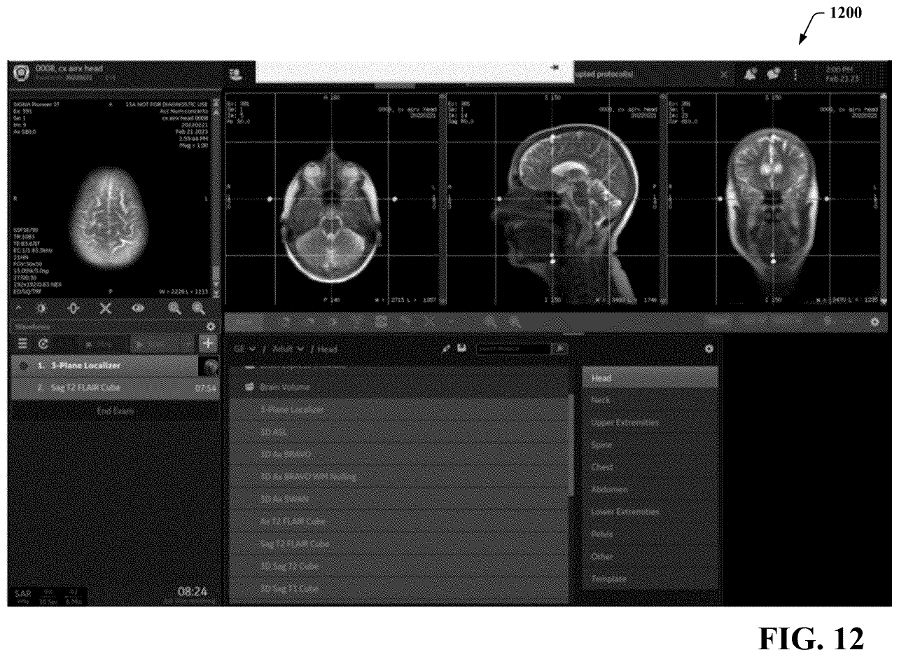

FIG. 11 illustrates a diagram of an example, non-limiting dashboard 1100 that shows images of a human knee, and FIG. 12 illustrates a diagram of an example, non-limiting dashboard 1200 that shows images of a human brain resulting from an iMPR workflow in accordance with one or more embodiments described herein. Repetitive description of like elements and/or processes employed in respective embodiments is omitted for sake of brevity.

Non-limiting dashboards 1100 and 1200 show how image reformatting, which is a known image processing technique, can be performed. Non-limiting dashboard 1100 illustrates an iMPR workflow for the anatomy of a human knee. Similarly, non-limiting dashboard 1200 illustrates an intelligent multi-planar reformatting workflow for the anatomy of the human brain. Both workflows were generated by integrating/implementing the iMPR tool into an MR console S/W using imaging fabric in conjunction with the AIRx™ suite of applications.

Multi-planar reformatting of a volume (e.g., associated with an anatomical landmark) can convert the volume from existing planes corresponding to the volume (e.g., from a format that the volume is acquired in) to a different set of planes. In various embodiments, intelligent multi-planar reformatting can reformat diagnostic images along plane orientations aligned to anatomical references that are computed from APS.

AIRx™ was experimentally employed as the APS to generate the proof of concept (POC) for the embodiments of the present disclosure, and non-limiting dashboard 1100 shows a snapshot of the experimentation. Additionally, the robustness of each component/module comprised in performance evaluation component 110 was tested. In various embodiments, the workflow shown by non-limiting dashboard 1100 can be employed to generate reformatted diagnostic images (i.e., more imaging data) to evaluate APS performance. However, in various embodiments, the process of reformatting diagnostic images can be an offline process that can be performed by an algorithm (e.g., image reformatting component 206). For example, in one or more embodiments, an image reformatting software can be employed by image reformatting component 206 as the iMPR tool. In an embodiment, the image reformatting software can be deployed at the backend or on the cloud. In some embodiments, the image reformatting software can be part of an automated continuous integration and continuous delivery/deployment (CICD).

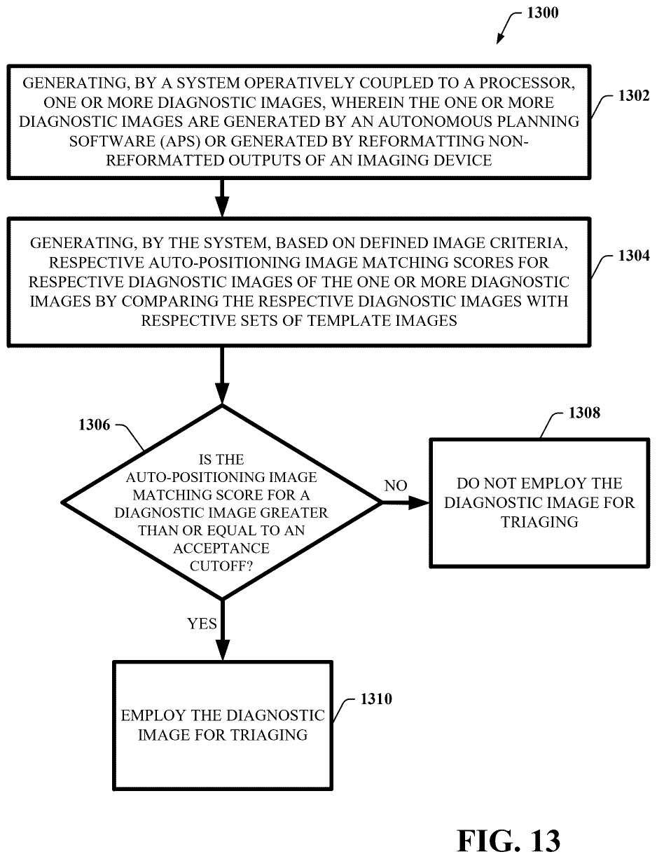

FIG. 13 illustrates a flow diagram of an example, non-limiting method 1300 that can employ generative AI to evaluate performance of an APS in accordance with one or more embodiments described herein. Repetitive description of like elements and/or processes employed in respective embodiments is omitted for sake of brevity.

At 1302, non-limiting method 1300 can comprise generating (e.g., by image generation component 202), by a system operatively coupled to a processor, one or more diagnostic images, wherein the one or more diagnostic images are generated by an APS or generated by reformatting non-reformatted outputs of an imaging device.

At 1304, non-limiting method 1300 can comprise generating (e.g., by image evaluation component 208), by the system, based on defined image criteria, respective auto-positioning image matching scores for respective diagnostic images of the one or more diagnostic images by comparing the respective diagnostic images with respective sets of template images.

At 1306, non-limiting method 1300 can comprise determining (e.g., by computation component 210), by the system, whether the auto-positioning image matching score for a diagnostic image is greater than or equal to an acceptance cutoff.

If yes, then at 1310, non-limiting method 1300 can comprise employing (e.g., by computation component 210), by the system, the diagnostic image for triaging because the auto-positioning image matching score can indicate that the diagnostic image is of acceptable quality for triaging.

If not, then at 1308, non-limiting method 1300 can comprise not employing (e.g., by computation component 210), by the system, the diagnostic image for triaging because the auto-positioning image matching score can indicate that the diagnostic image is not a good representation generated by the APS.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 14 and the following discussion are intended to provide a brief, general description of a suitable computing environment 1400 in which the various embodiments described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and a drive 1420, e.g., such as a solid state drive, an optical disk drive, which can read or write from a disk 1422, such as a CD-ROM disc, a DVD, a BD, etc. Alternatively, where a solid state drive is involved, disk 1422 would not be included, unless separate. While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and drive 1420 can be connected to the system bus 1408 by an HDD interface 1424, an external storage interface 1426 and a drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the OS kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples and other means of establishing a communications link between the computers can be used.

When used in either a LAN or WAN networking environment, the computer 1402 can access cloud storage systems or other network-based storage systems in addition to, or in place of, external storage devices 1416 as described above, such as but not limited to a network virtual machine providing one or more aspects of storage or processing of information. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

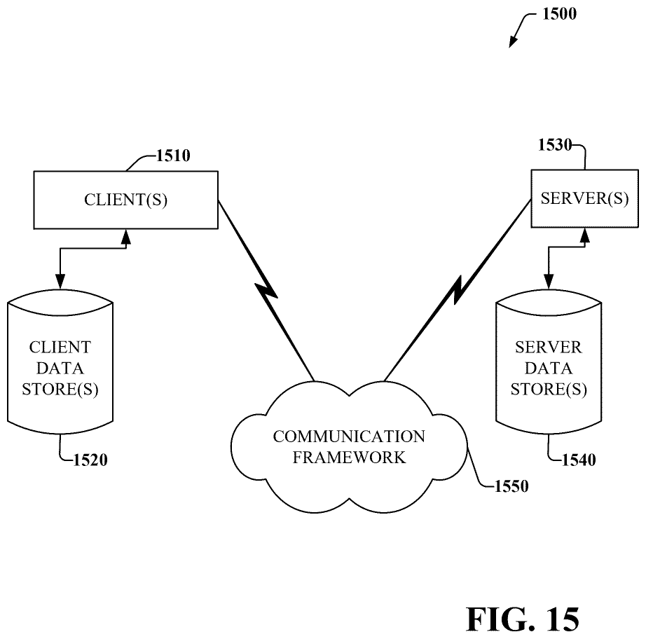

FIG. 15 is a schematic block diagram of a sample computing environment 1500 with which the disclosed subject matter can interact. The sample computing environment 1500 includes one or more client(s) 1510. The client(s) 1510 can be hardware or software (e.g., threads, processes, computing devices). The sample computing environment 1500 also includes one or more server(s) 1530. The server(s) 1530 can also be hardware or software (e.g., threads, processes, computing devices). The servers 1530 can house threads to perform transformations by employing one or more embodiments as described herein, for example. One possible communication between a client 1510 and a server 1530 can be in the form of a data packet adapted to be transmitted between two or more computer processes. The sample computing environment 1500 includes a communication framework 1550 that can be employed to facilitate communications between the client(s) 1510 and the server(s) 1530. The client(s) 1510 are operably connected to one or more client data store(s) 1520 that can be employed to store information local to the client(s) 1510. Similarly, the server(s) 1530 are operably connected to one or more server data store(s) 1540 that can be employed to store information local to the servers 1530.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
an image generation component that generates one or more diagnostic images; and
an image evaluation component that generates, based on defined image criteria, respective auto-positioning image matching scores for respective diagnostic images of the one or more diagnostic images by comparing the respective diagnostic images with respective sets of template images.

2. The system of claim 1, wherein the one or more diagnostic images are generated by an autonomous planning software (APS) or generated by reformatting non-reformatted outputs of an imaging device, wherein the APS further generates prescription plans for the one or more diagnostic images, and wherein the image evaluation component employs a set of foundation models and a vision transformer to generate the respective auto-positioning image matching scores.

3. The system of claim 1, wherein comparing a diagnostic image of the respective diagnostic images with a template image comprised in a set of template images comprises:
extracting a first set of features from the template image;
extracting a second set of features from the diagnostic image; and
computing a similarity score based on the first set of features and the second set of features, wherein the similarity score indicates a degree of similarity between the diagnostic image and the template image.

4. The system of claim 1, wherein the image evaluation component performs majority voting based on similarity scores corresponding to the respective diagnostic images to determine whether the respective diagnostic images contain metal.

5. The system of claim 1, further comprising:
a computation component that computes tolerance values based on the respective auto-positioning image matching scores, wherein the tolerance values are employable to define image quality metrics for APS.

6. The system of claim 1, further comprising:
a data selection component that selects one or more datasets from a plurality of databases, wherein the one or more datasets are selected according to the defined image criteria, and wherein the one or more datasets are employable to generate the one or more diagnostic images.

7. The system of claim 2, further comprising:
an image reformatting component that transforms respective non-reformatted outputs of the non-reformatted outputs into respective reformatted diagnostic images by employing an intelligent multi-planar (iMPR) reformatting tool.

8. The system of claim 1, wherein the respective auto-positioning image matching scores indicate performance of the APS in diagnostic imaging.

9. A computer-implemented method, comprising:
generating, by a system operatively coupled to a processor, one or more diagnostic images; and
generating, by the system, based on defined image criteria, respective auto-positioning image matching scores for respective diagnostic images of the one or more diagnostic images by comparing the respective diagnostic images with respective sets of template images.

10. The computer-implemented method of claim 9, wherein the one or more diagnostic images are generated by an autonomous planning software (APS) or generated by reformatting non-reformatted outputs of an imaging device, wherein the APS further generates prescription plans for the one or more diagnostic images, and wherein the respective auto-positioning image matching scores are generated by employing a set of foundation models and a vision transformer.

11. The computer-implemented method of claim 9, wherein comparing a diagnostic image of the respective diagnostic images with a template image comprised in a set of template images comprises:
extracting, by the system, a first set of features from the template image;
extracting, by the system, a second set of features from the diagnostic image; and
computing, by the system, a similarity score based on the first set of features and the second set of features, wherein the similarity score indicates a degree of similarity between the diagnostic image and the template image.

12. The computer-implemented method of claim 9, further comprising:
performing, by the system, majority voting based on similarity scores corresponding to the respective diagnostic images to determine whether the respective diagnostic images contain metal.

13. The computer-implemented method of claim 9, further comprising:
computing, by the system, tolerance values based on the respective auto-positioning image matching scores, wherein the tolerance values are employable to define image quality metrics for APS.

14. The computer-implemented method of claim 9, further comprising:
selecting, by the system, one or more datasets from a plurality of databases, wherein the one or more datasets are selected according to the defined image criteria, and wherein the one or more datasets are employable to generate the one or more diagnostic images.

15. The computer-implemented method of claim 10, further comprising:
transforming, by the system, respective non-reformatted outputs of the non-reformatted outputs into respective reformatted diagnostic images by employing an intelligent multi-planar (iMPR) reformatting tool.

16. The computer-implemented method of claim 9, wherein the respective auto-positioning image matching scores indicate performance of the APS in diagnostic imaging.

17. A computer program product comprising a non-transitory computer readable memory having program instructions embodied therewith, the program instructions executable by a processor to cause the processor to:
generate one or more diagnostic images; and
generate, based on defined image criteria, respective auto-positioning image matching scores for respective diagnostic images of the one or more diagnostic images by comparing the respective diagnostic images with respective sets of template images.

18. The computer program product of claim 17, wherein the one or more diagnostic images are generated by an autonomous planning software (APS) or generated by reformatting non-reformatted outputs of an imaging device, wherein the APS further generates prescription plans for the one or more diagnostic images, and wherein the program instructions are further executable by the processor to cause the processor to:
employ a set of foundation models and a vision transformer to generate the respective auto-positioning image matching scores.

19. The computer program product of claim 17, wherein the program instructions are further executable by the processor to cause the processor to:
compare a diagnostic image of the respective diagnostic images with a template image comprised in a set of template images by:
extracting a first set of features from the template image;
extracting a second set of features from the diagnostic image; and
computing a similarity score based on the first set of features and the second set of features, wherein the similarity score indicates a degree of similarity between the diagnostic image and the template image.

20. The computer program product of claim 17, wherein the program instructions are further executable by the processor to cause the processor to:
perform majority voting based on similarity scores corresponding to the respective diagnostic images to determine whether the respective diagnostic images contain metal.
